(19) United States
(12) Patent Application Publication
(10) Pub. No.: US 2015/0178321 A1
(43) Pub. Date: Jun. 25, 2015

(54) IMAGE-BASED 3D MODEL SEARCH AND RETRIEVAL

(71) Applicant: Google Inc., (US)

(72) Inventors: Ehud Rivlin, Haifa (IL); Maks Ovsjanikov, Menlo Park, CA (US)

(73) Assignee: Google Inc., Mountain View, CA (US)

(21) Appl. No.: 13/796,936

(22) Filed: Mar. 12, 2013

Related U.S. Application Data
(60) Provisional application No. 61/622,236, filed on Apr. 10, 2012.

(51) Int. Cl. G06F 17/30

(52) U.S. Cl. CPC G06F 17/30277

(57) ABSTRACT

A query may be associated with 3D models based on the relevancy of each 3D model to the query. For a given query, a set of views are selected from a 3D model. Relevance scores are assigned to the views based on image features that are shared with popular on-line images that are accessed based on the query. The relevance scores of the views are aggregated to provide the 3D model with a relevance score. In response to a user search for a 3D model, the model having the highest relevance score for a query that matches the search is selected and returned to the user. The 3D model may be displayed with the 2D view that has the highest relevance score. In some cases, a set of 3D models having the highest relevance scores is returned to the user such that the user may select an appropriate 3D model.

### CROSS-REFERENCE TO RELATED APPLICATIONS

The present application claims the benefit of the filing date of U.S. Provisional Patent Application No. 61/622,236 filed Apr. 10, 2012, the disclosure of which is hereby incorporated herein by reference.

### BACKGROUND

This specification relates to returning three dimensional (3D) model selection and, more particularly, to returning relevant 3D models in response to a search based on the content of the 3D models.

In 3D computer graphics, 3D modeling is a process of developing a mathematical representation of any three-dimensional object surface using specialized software. 3D models represent a three-dimensional view of an object using a collection of points in 3D space, connected by various geometric entities such as triangles, lines and curved surfaces. The resulting 3D model may be displayed as a two-dimensional image through a process called 3D rendering or used in a computer simulation of physical phenomena.

One technique for searching three dimensional models involves the use of tags. 3D model creators may attach tags to a 3D model such that other users may search for and locate relevant 3D models that are tagged with corresponding query terms.

### SUMMARY

Aspects of the disclosure are directed to providing a relevant three dimensional model in response to a search query. In a preprocessing stage, two dimensional (2D) views of each 3D model are sampled. A query may be generated based on textual metadata extracted from at least some of the 2D views or may be submitted by a user. An image feature scorer assigns a feature vector to each 2D view based on corresponding image features. The image feature scorer uses the query to access web images and corresponding user data to identify which images are most popular with web users and which images are commonly overlooked for that query. Image features are extracted from the accessed web images and a feature vector is assigned to each accessed web image.

A relevance score is assigned to each 2D view of the 3D model based on a comparison between the feature vector of the 2D view and the feature vectors of the web images. The relevance scores for each 2D view for a given 3D model are aggregated to provide a relevance score for the 3D model. The 3D models may then be ranked for she query based on the corresponding relevance scores. The 2D view that resulted in the highest individual relevance score may be identified as the best representation of the 3D model.

When a user submits a search to locate a particular 3D model, a 3D model or a set of the 3D models that had been previously ranked for the same or substantially similar query are identified and provided to the user based on the 3D models having the highest aggregate relevance score. The 3D models may be displayed to the user as 2D views that have the highest individual relevance scores for a particular 3D model.

In some aspects, a computer-implemented method includes receiving a first query at a processor. A ranking of a plurality of different three-dimensional models is accessed from memory. Each three-dimensional model is ranked based on a relevance score which indicates a level of correspondence between each three-dimensional model and a second query. The second query is substantially similar to the first query. The three-dimensional model having the relevance score that indicates the highest level of correspondence between the three-dimensional model and the second query is output to a display.

In some aspects, a system includes a memory and a processor. The memory stores a plurality of 3D models, and each 3D model includes a plurality of 2D views. The processor configured to receive a first query; access a ranking of a plurality of different three-dimensional models from the memory, wherein each three-dimensional model is ranked based on a relevance score which indicates a level of correspondence between each three-dimensional model and a second query, wherein the second query is substantially similar to the first query; and output, to a display, the three-dimensional model having the relevance score that indicates the highest level of correspondence between the three-dimensional model and the second query.

In some aspects, a computer-implemented method includes receiving a query that includes data associated with a user's interest in a three-dimensional (3D) model. The 3D model is accessed from memory based on the query. The 3D model is sampled to obtain a plurality of candidate views using a processor. Image features are extracted from each of the plurality of candidate views. A plurality of web images and user data associated with each of the web images are accessed from an image database. The web images are accessed based on the query. Image features are extracted from the plurality of web images. A feature vector is generated for each of the plurality of candidate views and each of the plurality of web images based on the image features extracted from the corresponding candidate view or web image. A relevance score is calculated for each of the plurality of candidate views images using the processor. The relevance score indicates a relevance between a corresponding candidate view and the query. The relevance score is calculated by comparing the feature vector of the corresponding candidate view to the feature vectors of the web images. A given one of the candidate views that is associated with the highest relevance score is output. The output candidate view provides the best representative view of the 3D model.

In some aspects, a system includes: 1) a memory storing a plurality of 3D models, and 2) a processor including a view selector module. Each 3D model includes a plurality of views. The view selector module is configured to: receive a query including data associated with a user's interest in a first 3D model; access the first 3D model from the memory based on the query; sample the first 3D model to obtain a plurality of candidate views of the first 3D model; and extract image features from each of the plurality of candidate views. The view selector module includes an image feature scorer configured to: access a plurality of web images and user data associated with each of the web images from an image database, wherein the web images are accessed based on the query; extract image features from each of the web images; generate a feature vector for each of the plurality of candidate views and each of the plurality of web images, wherein each feature vector is generated based on the image features extracted from the corresponding candidate view or web image; calculate a relevance score for each of the plurality of candidate views, wherein the relevance score indicates a relevance between the corresponding candidate view and the query, the relevance score being calculated by comparing the feature vector of the corresponding candidate view to the feature vectors of the web images; and output a given one of the candidate views that is associated with the highest relevance score, wherein the output candidate view provides the best representative view of the 3D model.

In some aspects, a system includes a memory and a processor. The memory stores a plurality of three-dimensional models, and each three-dimensional model includes a plurality of two-dimensional views. The processor configured to obtain a first query; access a ranking of a plurality of different three-dimensional models from the memory, wherein each three-dimensional model is ranked based on a relevance score which indicates a level of correspondence between the three-dimensional model and a second query that is substantially similar to the first query, wherein each three-dimensional model comprises a plurality of two-dimensional views; and provide for presentation the three-dimensional model having the relevance score that indicates the highest level of correspondence between the three-dimensional model and the second query, wherein the relevance score is an aggregate of relevance values of the two-dimensional views, the relevance value of each two-dimensional view indicating a level of relevance between the two-dimensional view and the second query.

In some aspects, a computer-implemented method includes receiving a query that includes data associated with a user's interest in a three-dimensional (3D) model. The 3D model is accessed from memory based on the query. The 3D model is sampled to obtain a plurality of candidate views using a processor. Image features are extracted from each of the plurality of candidate views. A plurality of web images and user data associated with each of the web images are accessed from an image database. The web images are accessed based on the query. Image features are extracted from the plurality of web images. A feature vector is generated for each of the plurality of candidate views and each of the plurality of web images based on the image features extracted from the corresponding candidate view or web image. A relevance score is calculated for each of the plurality of candidate views images using the processor. The relevance score indicates a relevance between a corresponding candidate view and the query. The relevance score is calculated by comparing the feature vector of the corresponding candidate view to the feature vectors of the web images. A given one of the candidate views that is associated with the highest relevance score is output. The output candidate view provides the best representative view of the 3D model.

In some aspects, a system includes: 1) a memory storing a plurality of 3D models, and 2) a processor including a view selector module. Each 3D model includes a plurality of views. The view selector module is configured to: receive a query including data associated with a user's interest in a first 3D model; access the first 3D model from the memory based on the query; sample the first 3D model to obtain a plurality of candidate views of the first 3D model; and extract image features from each of the plurality of candidate views. The view selector module includes an image feature scorer configured to: access a plurality of web images and user data associated with each of the web images from an image database, wherein the web images are accessed based on the query; extract image features from each of the web images; generate a feature vector for each of the plurality of candidate views and each of the plurality of web images, wherein each feature vector is generated based on the image features extracted from the corresponding candidate view or web image; calculate a relevance score for each of the plurality of candidate views, wherein the relevance score indicates a relevance between the corresponding candidate view and the query, the relevance score being calculated by comparing the feature vector of the corresponding candidate view to the feature vectors of the web images; and output a given one of the candidate views that is associated with the highest relevance score, wherein the output candidate view provides the best representative view of the 3D model.

One technical advantage of the disclosure is the increased efficiency with which 3D models may be searched and returned to a user.

### BRIEF DESCRIPTION OF THE DRAWINGS

FIG. 1 illustrates a system in accordance with some implementations.

FIG. 2 illustrates aspects of the system of FIG. 1.

FIG. 3 illustrates a system for query-specific selection of a three dimensional model in accordance with some implementations.

FIGS. 4a and 4b illustrate 3D model sampling to obtain candidate views.

FIGS. 5 and 6 illustrate methods for query-specific best view selection of a three dimensional model in accordance with some implementations.

FIG. 7 illustrates a system for query-specific selection of a three dimensional model in accordance with some implementations.

FIGS. 8-11 illustrate methods for query-specific selection of a three dimensional model in accordance with some implementations.

### DETAILED DESCRIPTION

The aspects, features and advantages of the present disclosure will be appreciated when considered with reference to the following description of accompanying figures. The following description does not limit the disclosure; rather, the scope is defined by the appended claims and equivalents.

While certain processes in accordance with some implementations are shown in the figures as occurring in a linear fashion, this is not a requirement unless expressly stated herein. Different processes may be performed in a different order or concurrently.

The disclosure describes query-specific selection of a 3D model. A 3D model may show different aspects of a representative object as different 2D views. Example queries may be generated based on textual metadata from a particular 3D model or may be received from users. The queries may summarize a potential searcher's interest in selecting a particular 3D model. An image analysis technique may be performed during a preprocessing stage to identify representative 3D models that best correspond to each query. The image analysis technique involves the use of a trained image feature scorer that provides a relevance score to each 2D view of each 3D model in a data store of 3D models relative to a particular query. For each 3D model, the relevance scores of the corresponding 2D views can be aggregated. A high aggregate relevance score can indicate that the 3D model corresponds well to the query, while a low aggregate relevance score can indicate that the 3D model is not likely to correspond to the query.

In response to a user search for a 3D model, a 3D model or a set of 3D models that correspond to the highest aggregate relevance scores for a query that matches the user search terms are selected and output to the user. Each 3D model may be displayed to the user as the 2D view that is associated with the highest individual relevance score. The user may then select an appropriate 3D model from the set of displayed 2D views.

In one illustrative example, a query that includes the term “bridge” may be analyzed in a preprocessing stage. A search for “bridge” may identify ten 3D models of a bridge each including hundreds of 2D views. A web search for “bridge” may return more than one million images that are tagged “bridge” from an image database. From the image results, a model is created for what a representative view of a bridge should look like. For example, one thousand images for “bridge” may be selected and analyzed using image features, e.g., feature points, histograms of colors, etc., extracted from each image. The image features are used to determine the most common features associated with bridge images that are frequently accessed by web users.

The image features of the web images are used to generate a corresponding feature vector for each web image. Feature vectors are also generated for at least some of the 2D views of each 3D model. Each 3D model may be trained by comparing the feature vectors of the 2D bridge views to the feature vectors of the bridge web images. Once a 3D model is trained, candidate 2D views of the 3D model may be fed to the 3D model to calculate a relevance score for each 2D view. The relevance scores of the 2D views of a given 3D model are then aggregated to provide each 3D model with its own relevance score. The 3D models that have high relevance scores are likely 3D models that are relevant to the query, and the 3D models that have low relevance scores would not be relevant to the query.

By scoring each 3D model against a particular query, a determination can be made as to which 3D model should be presented to a user in response to a user search that is the same as, or similar to, the query. Accordingly, the 3D model that most closely corresponds to the most popular bridge web images, as indicated by the highest aggregate relevance score, is output to the user in response to the user search. The 3D model may be displayed as the 2D view that has the highest individual relevance score which would correspond to the best representation of a bridge image. In some cases, a set of 3D models that have the highest aggregate relevance scores may be returned to the user for display such that the user may select an appropriate bridge 3D model from the set.

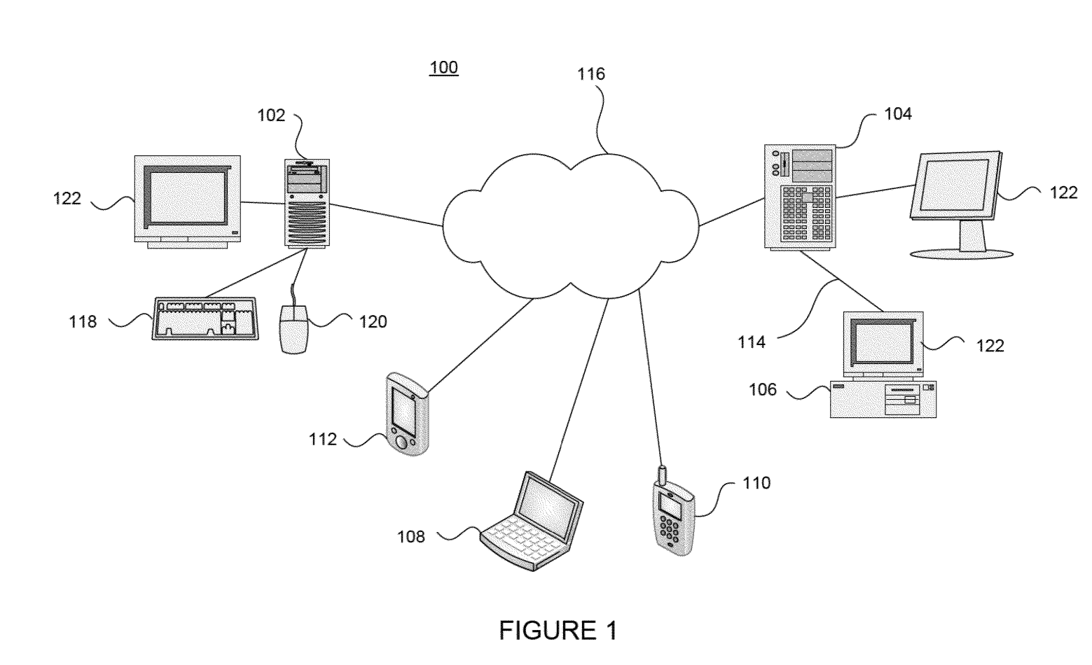

FIG. 1 presents a schematic diagram of a computer system depicting various computing devices that can be used alone or in a networked configuration in accordance with aspects of the invention. For example, FIG. 1 illustrates a computer network 100 having a plurality of computers 102, 104, 106, 108 as well as other types of devices such as a mobile phone 110 and a PDA 112. Such devices may be interconnected using a local or direct connection 114 and/or may be coupled using a network 116 such as a LAN, WAN, the Internet, etc., which may be wired or wireless.

Each device may include, for example, one or more processing devices and have user inputs such as a keyboard 118 and mouse 120 and/or various other types of input devices such as pen-inputs, joysticks, buttons, touch screens, etc., as well as a display 122, which could include, for instance, a CRT, LCD, plasma screen monitor, TV, projector, etc. Each computer 102, 104, 106, 108 may be a personal computer, server, etc. By way of example only, computers 102, 106 may be personal computers while computer 104 may be a server and computer 108 may be a laptop.

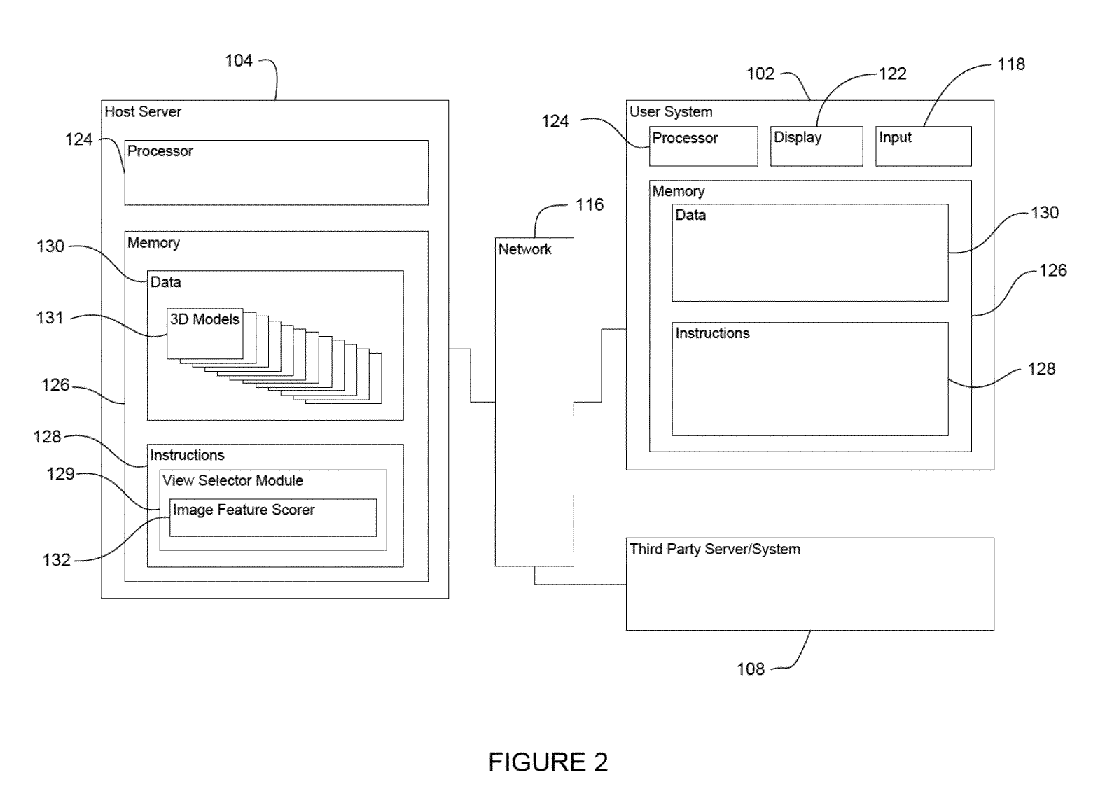

As shown in FIG. 2, each computer, such as computers 102, 104, contains a processor 124, memory/storage 126 and other components typically present in a computer. For instance, memory/storage 126 stores information accessible by processor 124, including instructions 128 that may be executed by the processor 124 and data 130 that may be retrieved, manipulated or stored by the processor 124. The memory/storage 126 may be of any type or any device capable of storing information accessible by the processor, such as a hard-drive, ROM, RAM, CD-ROM, flash memories, write-capable or read-only memories. The processor 124 may include any number of well known processors, such as a CPU. Alternatively, the processor may be a dedicated controller for executing operations, such as an ASIC.

The instructions 128 may include any set of instructions to be executed directly, such as machine code, or indirectly, such as scripts, by the processor(s). In that regard, the terms “instructions,” “steps” and “programs” may be used interchangeably herein. The instructions may be stored in any computer language or format, such as in object code or modules of source code. The instructions 128 on computer 104 may include a view selector module 129 for selecting a 3D model in response to a user query, and a best representative view of the selected 3D model. The view selector module 129 includes an image feature scorer 132 for assigning a relevance score to different images based on example queries. The functions, methods and routines of the instructions 128, particularly the view selector module 129 and the image feature scorer 132, are described in detail below.

Data 130 may be retrieved, stored or modified by processor 124 in accordance with the instructions 128. The data 130 may be stored as a collection of data. The data 130 stored on computer 104 includes a collection of 3D models 131 that may be selected in response to a user query, as described in detail below.

The data 130 may also be formatted in any computer readable format such as, but not limited to, binary values, ASCII or Unicode. Similarly, the data may include images stored in a variety of formats such as vector-based images or bitmap images using lossless, e.g., PNG, or lossy, e.g., JPEG, encoding. Moreover, the data may include any information sufficient to identify the relevant information, such as descriptive text, proprietary codes, pointers, references to data stored in other memories including other network locations, or information which is used by a function to calculate the relevant data.

Although the processor 124 and memory 126 are functionally illustrated in FIG. 2 as being within the same block, it will be understood that the processor 124 and memory 126 may actually include multiple processors and memories that may or may not be stored within the same physical housing or location. For example, some or all of the instructions and data may be stored on a removable CD-ROM and others within a read-only computer chip. Some or all of the instructions and data may be stored in a location physically remote from, yet still accessible by, the processor. Similarly, the processor may actually include a collection of processors which may or may not operate in parallel. Data may be distributed and stored across multiple memories 126 such as hard drives or the like.

The computer 104 may communicate with one or more client computers 102, 106 and/or 108, as well as devices such as mobile phone 110 and PDA 112. Each client computer or other client device may be configured similarly to the computer 102, with a processor, memory and instructions, as well as one or more user input devices 118 and a user output device, such as display 122. Each client computer may be a general purpose computer, intended for use by a person, having all the components normally found in a personal computer such as a central processing unit (“CPU”), display, CD-ROM or DVD drive, hard-drive, mouse, keyboard, touch-sensitive screen, speakers, microphone, modem and/or router, and all of the components used for connecting these elements to one another.

The computer 104 and other devices are capable of direct and indirect communication with other computers, such as over network 116. Although only a few computing devices are depicted in FIGS. 1 and 2, it should be appreciated that a typical system can include a large number of connected servers and clients, with each different computer being at a different node of the network. The network 116, and intervening nodes, may include various configurations and protocols including the Internet, intranets, virtual private networks, wide area networks, local networks, private networks using communication protocols proprietary to one or more companies, Ethernet, WiFi, Bluetooth or TCP/IP.

Communication across the network 116, including any intervening nodes, may be facilitated by any device capable of transmitting data to and from other computers, such as modems, e.g., dial-up or cable, network interfaces and wireless interfaces. Although certain advantages are obtained when information is transmitted or received as noted above, other aspects are not limited to any particular manner of transmission of information. For example, in some aspects, the information may be sent using a medium such as a disk, tape, CD-ROM, or directly between two computer systems using a dial-up modem.

Moreover, computers and user devices in accordance with the techniques described herein may include any device capable of processing instructions and transmitting data to and from other computers, including network computers lacking local storage capability, PDAs with modems such as PDA 112 and Internet-capable wireless phones such as mobile phone 110.

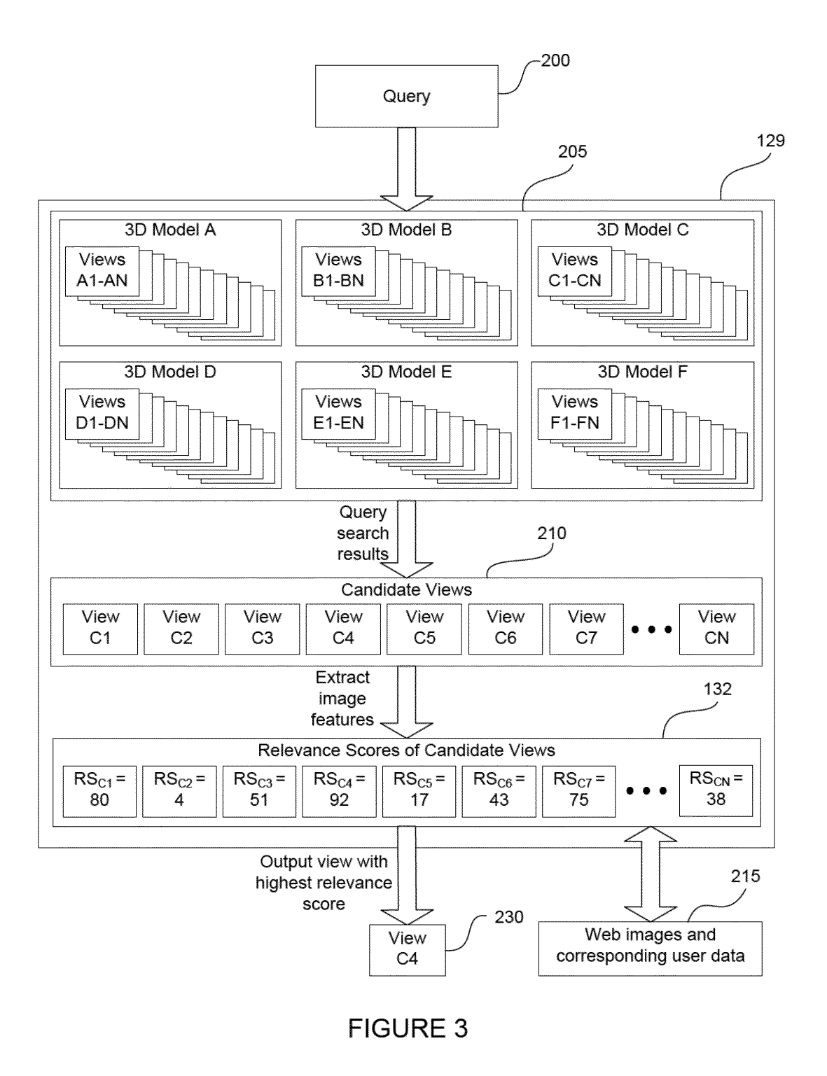

FIG. 3 illustrates a system for query-specific best view selection of a 3D model in accordance with some implementations. The system includes at least the view selector module 129, which includes the image feature scorer 132. The system has access to many different types of 3D models. Each 3D model includes different two-dimensional (2D) views of a particular object or scene.

In a preprocessing stage, example queries may be analyzed relative to particular 3D models. The queries may be generated based on textual metadata associated with individual 3D models, as described below, or the queries may be received from users requesting a particular 3D model. The query may include text that summarizes the user's interest in the 3D model. For example, the text query may include key words or search terms selected by the user to identify and locate a specific 3D model. An example text query may be “Eiffel Tower.” In response, as described below, the system determines which 3D model or models best correspond to the query. When the 3D model is output to the user, a best representative view of the 3D model is provided for display.

The 3D models that are accessible to the user may be stored locally or on a host server. Each 3D model may be represented as a mesh, a point cloud or any other renderable format. In the event that the 3D model is not in a renderable format, the 3D model may be converted into a format from which candidate views may be rendered and accessed.

As shown in FIG. 3, the different 3D models are stored in memory 205 as 3D Model A, 3D Model B, 3D Model C, 3D Model D, 3D Model E and 3D Model F. Each 3D model includes a large number of 2D views. For example, 3D Model A may include Views A1 through AN, 3D Model B may include Views B1 through BN, 3D Model C may include Views C1 through CN, 3D Model D may include Views D1 through DN, 3D Model E may include Views E1 through EN, and 3D Model F may include Views F1 through FN.

In response to the query 200, a 3D model that may correspond to the query 200 is selected for analysis. In some implementations, the 3D model may be tagged with key words such that when the same or similar key words are included in a text query, the 3D model is identified and selected. In the “Eiffel Tower” example, a 3D model that is tagged as “Eiffel Tower” may be selected. For illustrative purposes, 3D Model C is selected as being a 3D model that corresponds to the Eiffel Tower. The other 3D models may correspond to non-Eiffel Tower models. For example, 3D Model A may be a 3D model of a bridge and 3D Model B may be a 3D model of a laptop computer.

The views C1-CN that are included in the 3D model of 3D Model C are then selected and analyzed as candidate views 210 to determine the best representative view of the requested 3D model. The candidate views 210 may be different two dimensional (2D) views of the 3D model. In some implementations, all of the 2D views are analyzed for the selected 3D model. In some implementations, a set of candidate views is sampled. The output of the sampling is a set of 2D views, but the view that best represents the 3D model is not yet determined.

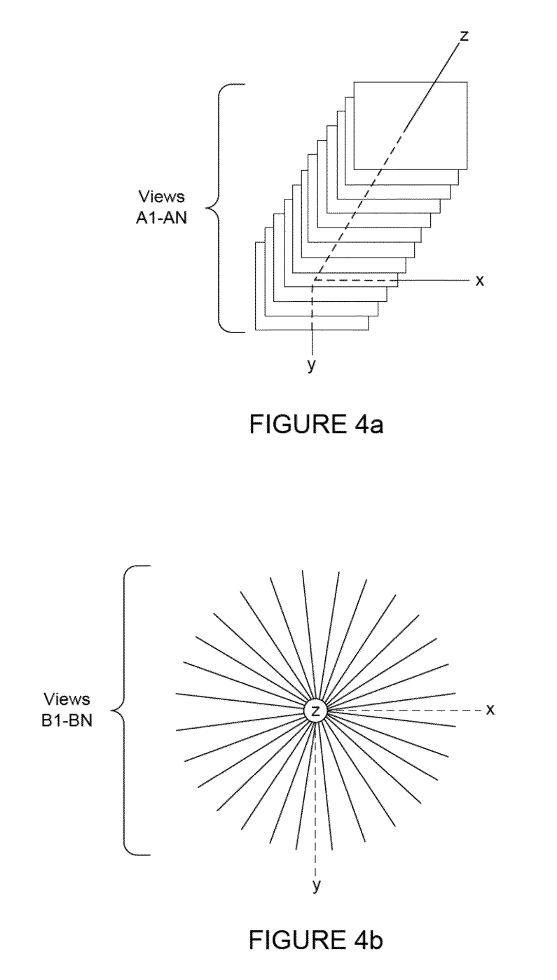

Referring to FIG. 4a, a set of candidate views A1-AN may be sampled from a one dimensional direction. For example, for a given 3D model, one hundred candidate views may be sampled along the z-axis such that each candidate view provides a planar, two-dimensional view parallel to the x-y plane.

Referring to FIG. 4b, a set of candidate views B1-BN may be images that are sampled from a view sphere of the 3D model. In this implementation, each two-dimensional candidate view is provided in a separate plane that intersects the same line, e.g., the z-axis, as the other candidate views in the set. In one example of sampling a view sphere, the candidate views are selected from the 3D model by rendering a set of twenty-eight views which evenly sample a circle parallel to the x-y plane at a fixed z elevation. This process of candidate view sampling and selection assumes that the 3D model is created such that the down direction is parallel to the z-axis, which is generally true for most 3D models. However, in general, one may uniformly sample the smallest enclosed sphere around the 3D model and generate candidate views from all sample positions.

After the candidate views 210 are selected, the view selector module 129 extracts image features from each of the candidate views. The image features may be abstractions or statistics that are specific to the candidate view. The image features may include a large number of low level image descriptors such as color histograms, edge detectors, aggregated feature point descriptors, feature points, etc. The extracted image features may provide a fixed-sized, vector representation of the corresponding candidate view. The vector representation may be referred to as a feature vector. Each candidate view 210 of the 3D model, e.g., 3D Model C, may be represented as a feature vector using image-feature vector conversion, e.g., MPEG-7 image feature specification with post-processing.

The extracted image features are provided to the image feature scorer 132. The image feature scorer 132 is trained for the specific text query using a corpus of web images and corresponding user data 215. Using the “Eiffel Tower” text query, the image feature scorer 132 may access images that are tagged as “Eiffel Tower” from an image database. The image feature scorer 132 also accesses any user data that is associated with the accessed images, such as the click and view history associated with each web image. A web image's click and view history represents a number of times that the web image is accessed by users when presented by an image search result. The images and associated user data may be accessed by the image feature scorer 132 from a host server or from any other accessible storage location.

For each web image accessed, the image feature scorer 132 utilizes the user data to identify the image's popularity. Specifically, the image feature scorer 132 may be trained for the query 200 by promoting features from images on which users have clicked and viewed heavily and by demoting features from unpopular or irrelevant images. For example, an image of the Eiffel Tower that was captured on a clear day where the entire structure is positioned symmetrically within the frame of the image would be likely accessed much more frequently by many different users than an image captured on a rainy day or from a camera positioned directly below the tower. Using this technique, the image feature scorer 132 may determine which web images of the Eiffel Tower are the most popular, “positive images,” and which are irrelevant for being often overlooked by users, “negative images.”

The image feature scorer 132 may extract image features from the positive images and the negative images to generate a corresponding feature vector for each positive image and negative image. The feature vectors of the positive/negative images may be compared to the feature vector of each candidate view 210 to assign a relevance score (RS) to each candidate view 210. The relevance score indicates the relevance of the query to the candidate view 210 and vice versa. In some implementations, a high relevance score means that the candidate view is more relevant to the corresponding query than a view with a low relevance score.

For example, referring to FIG. 3, View C1 may be assigned a relevance score of 80, View C2 may be assigned a relevance score of 4, View C3 may be assigned a relevance score of 51, View C4 may be assigned a relevance score of 92, View C5 may be assigned a relevance score of 17, View C6 may be assigned a relevance score of 43, View C7 may be assigned a relevance score of 75, and View CN may be assigned a relevance score of 38. In this example, View C2 is the view that is the least likely to provide a good representative view of the 3D model in accordance with the query, and View C4 provides the best representative view of the “Eiffel Tower” 3D model. Accordingly, the view that is associated with the highest relevance score, e.g., View C4, is identified as the view that best represents the 3D model.

In some implementations, to facilitate efficiency, feature vectors for candidate views of a 3D model may be computed during the preprocessing stage. In other words, the training of the image feature scorer 132 may occur before a user requests a 3D model such that many queries may be pre-trained. Similarly, a 3D relevance model may be pre-trained for a particular query. Since the candidate views are scored for relevance against a set of possible queries, image feature extraction may be shared across different query scoring requests. In the event that a 3D relevance model has been previously trained for a query, the best candidate view of the 3D model may be readily accessed when that same query or substantially similar query for the 3D model is received without having to individually score each candidate view on-the-fly.

In the case of the “Eiffel Tower” query, the processing and analysis of the image feature scorer 132 would generally not provide the user with a view of the Eiffel Tower from the top or the bottom because these are not representative images; unless the user had a specific reason for requesting the top or bottom image. For example, in response to the user inputting a text query as “Eiffel Tower from the bottom”, there may not be representative candidate views available from the Eiffel Tower 3D model. In this case, a search of web images 215 may be performed to identify a view that corresponds to the query. The web images that are searched may not be renderings of 3D models. The web images may have been captured in a variety of ways, such as by casual users who took photos from under the Eiffel Tower and posted them on the Internet. However, these random photos that have been uploaded and publicly accessible are sufficient to provide the user with a good representative view of the Eiffel Tower from the bottom.

The “Eiffel Tower from the bottom” web images that are selected as views may be quite different from the 3D model candidate views selected for the “Eiffel Tower” query. The relevance scores associated with the “Eiffel Tower from the bottom” web images may also be quite different. However, as in the “Eiffel Tower” query, the web image that is associated with the highest relevance score for the “Eiffel Tower from the bottom” query is selected as the view for the 3D model that is output to the user.

In some implementations, there may not be any 3D models available that correspond to the user's query. The query may be so esoteric or particular that a 3D model may not have been created for the sought after object. For example, a user may submit a query for “Star Wars Death Star trench,” in an effort to locate a 3D model of the battle scene from the popular science fiction film. Even though the 3D model of such an object may not exist, the image database may still be searched to locate a two-dimensional image that best represents the requested scene from the film. This image would then be returned in response to the user's query.

Generally, the image feature scorer 132 is web-trained and query-specific to obtain the best representative view of the 3D model. However, any trained image scorer may be used to assign relevance scores to the candidate views. For example, a scorer based on prior knowledge may be used to assign relevance scores to each candidate view. The prior knowledge may be derived from, for example, an image classifier that is based on any type of off-line learning, e.g., a human trained with positives/negatives. In another example, a set of positive images may be stored for each text query, and the set may be accessed during scoring to perform image matching against an existing positive image that is understood to provide a good representative view of the 3D model. In this case, the scoring stage takes advantage of prior knowledge, rather than trying to figure out on-the-fly what the best representative view may be.

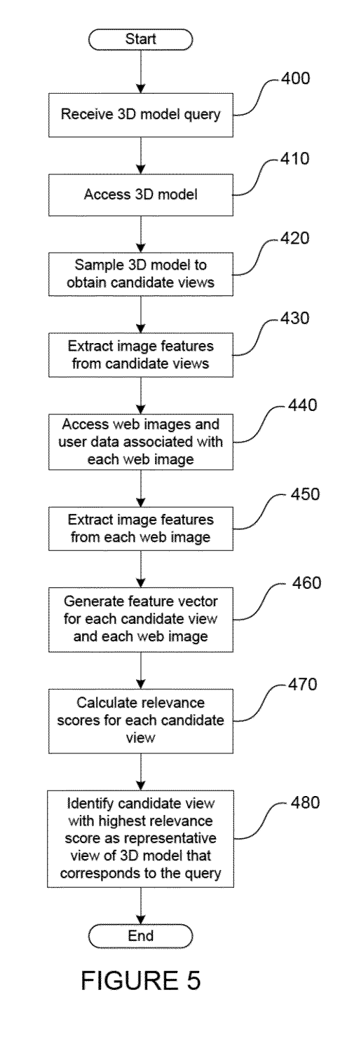

FIG. 5 illustrates a method for query-specific best view selection of a three dimensional model in accordance with some implementations. The method begins when a query for a 3D model is received (block 400). As previously described, the query may be received from a user as a character string that may correspond to a 3D model.

Alternatively, the query may be generated based on textual metadata associated with the 3D model. Each 3D model has associated textual metadata by which the 3D model may be identified. The textual metadata may include a title of the 3D model, a description, user-specified tags, comments from other users, etc. However, some of this information may be noisy and may not correspond to the actual content of the 3D model. The textual metadata may be extracted from each 3D model to generate queries to be analyzed relative to the 3D model. The textual metadata of each 3D model may be analyzed by: 1) selecting every sequence of N consecutive words in the metadata (where N is an integer), corresponding to N-gram extraction; 2) selecting entire sentences in a title and a description of the 3D model; and 3) appending fixed terms such as “3D,” “3D model,” “model of,” etc. to a list of results generated in steps 1) and 2).

The 3D model that corresponds to the query is accessed from memory (block 410). The accessed 3D model may be tagged with terms that correspond to the query, or the accessed 3D model may be the model from which the query was initially derived.

The 3D model is sampled to obtain candidate views (block 420). The candidate views may be different two dimensional (2D) views of the 3D model.

Image features are extracted from the candidate views (block 430). The image features are used to determine the most common features that are shared among images that are provided as results in response to the text query.

Web images and associated user data are accessed, e.g., from an image database, based on the query (block 440). The user data that is retrieved may be used to identify whether or not an image is commonly accessed by users. Image features are extracted from the web images (block 450).

A feature vector is generated for each candidate view and each web image (block 460). The feature vector is a functional representation of the image features for each candidate view or web image, and is generated based on the query using well-known techniques.

A relevance score is calculated for each candidate view (block 470). The relevance score identifies the relevance of the image features of the candidate view to the query. The relevance score for each candidate view is determined by comparing the feature vector of the candidate view with the feature vector of the web images. For example, a relevance score of candidate view that has a feature vector that substantially matches a feature vector of a popular web image, e.g., a web image that has been accessed continuously accessed by many different users, would indicate that the candidate view provides a good representative view of the 3D model.

The candidate view that has the highest relevance score is identified as being the best representative view of the 3D model that corresponds to the query (block 480). This candidate view may then be output when a user searches for the 3D model using the same or substantially similar query. In some implementations, an adjustment factor is provided to a query that is not the same as the query for which the 3D model is trained such that the substantially similar query may identify the most appropriate 3D model and corresponding best representative 2D view in response to a search.

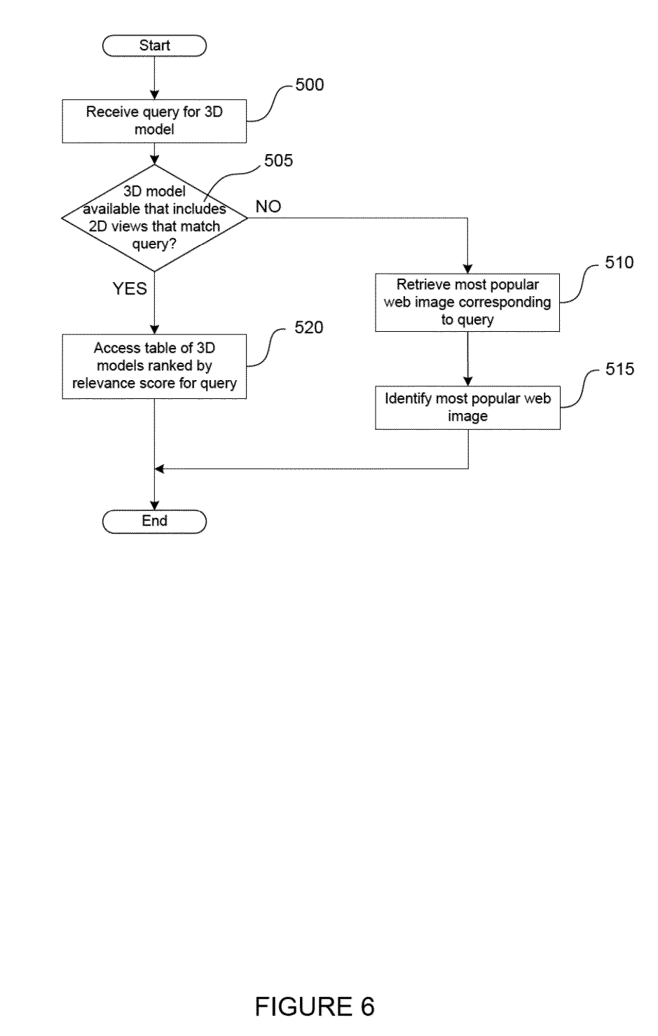

FIG. 6 illustrates a method for query-specific best view selection of a three dimensional model in accordance with some implementations. The method begins when a query for a 3D model is received (block 500). The query may be any character string that may correspond to a 3D model that is received by user submission or generated based on textual metadata of the 3D model. An example query may be “mouse” for a 3D model of a particular animal, or “Disney logo” for a 3D model of the “mouse ears” logo as used by the Disney® Corporation.

A determination is made as to whether the requested 3D model as expressed in the query is available (block 505). Each 3D model may be provided in a renderable format such that an image of the 3D model may be created from any particular view. Examples of renderable formats include a mesh, a point cloud, and a volumetric representation. In some cases, a 3D model that corresponds to the query is not available because the 3D model has not been created or because the 3D model cannot be properly matched to the query because the 3D model does not include two-dimensional views that correspond to the query.

In the event that a 3D model that corresponds to the query is unavailable, a most popular web image that corresponds to the query is retrieved from a database of available images (block 510). The web images in the database may have been captured in a variety of ways, such as by users who captured the images and uploaded them to the web for access by other users. The images may be any user-accessible images. A determination may be made that a web image is popular based on the query and user data, as described below with reference to determining which candidate view of the 3D model should be selected as the best representative view of the 3D model. The most popular web image may then be identified as providing a good representation of the requested 3D model (block 515), such that when a user subsequently requests the 3D model and the 3D model exists, the identified web image is returned as the representative view of the 3D model. Processing then terminates in the case where representative candidate views are not available from the 3D model or when there is no 3D model available that matches the query.

In the event that the requested 3D model is available, the table of 3D models ranked by aggregate relevance score is accessed for the corresponding search query (block 520). The aggregate relevance score for the 3D model is then computed relative to the query, as described previously. Processing then terminates.

When a user subsequently searches for the 3D model using terms that are the same as or substantially similar to the query, the best representative view is returned to the user for display. For example, the best representative view for the “mouse” query may be a side view of the 3D model that shows a mouse from a tip of the nose to a tip of the tail; whereas, if the query is “Disney® logo”, the best representative view of the 3D model may be an image of the three black circles that are a well-recognized indication of the Disney Corporation.

In addition to providing a best representative view of a 3D model, the disclosure may also be used to manage user-provided tags associated with 3D models. Often, tags are noisy and may even be purposefully manipulated by users to achieve higher rankings for the 3D models. Using the relevance scoring technique described above, irrelevant tags may be removed if there are no 2D views of the 3D model that generate a sufficiently high score. Furthermore, existing tags may be ranked with respect to the score of the best representative view. This allows promotion of the most relevant tags and demotion of irrelevant tags. In one implementation, the highest relevance score of the 3D model is used to determine whether or not tags of the 3D model are promoted or demoted. For example, in the event that the highest relevance score of the 3D model exceeds a threshold, at least one tag of the 3D model may be promoted. Similarly, in the event that the highest relevance score of the 3D model does not exceed a threshold, at least one tag of the 3D model may be demoted.

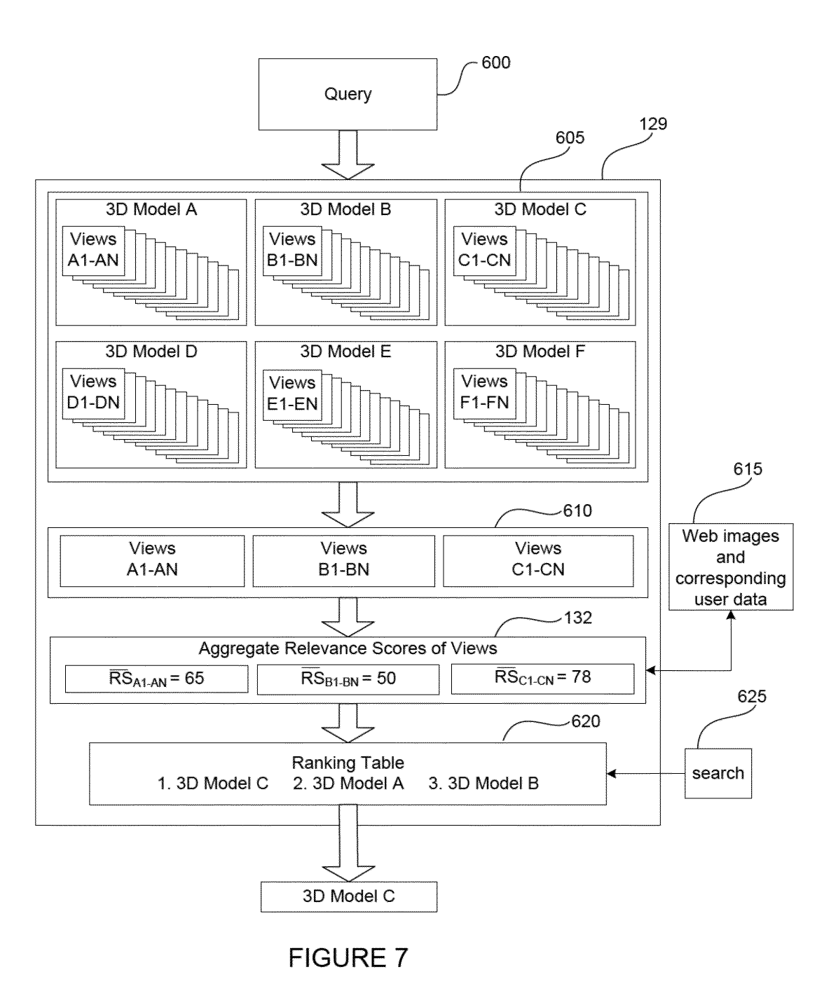

FIG. 7 illustrates a system for query-specific selection of a 3D model in accordance with some implementations. The system includes at least the view selector module 129 which includes the image feature scorer 132. The system has access to many different types of 3D models. Each 3D model includes different two-dimensional (2D) views of a particular object or scene. As described above, a query 600 may be generated based on textual metadata associated with a particular 3D model. In some cases, the query 600 may be submitted by a user as input to the system. The query summarizes the user's interest in the 3D model. For example, the query may include key words or search terms selected by the user to identify and locate a specific 3D model. An example text query may be “Golden Gate Bridge”. In response, as described below, the system identifies a ranked list of 3D models that corresponds to the query, and the highest ranked 3D model may be output to the user.

The 3D models that are accessible to the user may be stored locally or on a host server. Each 3D model may be represented as a mesh, a point cloud or any other renderable format. In the event that the 3D model is not in a renderable format, the 3D model is converted into a format from which 2D views may be rendered and accessed.

As shown in FIG. 7, the different 3D models are stored in memory 605 as 3D Model A, 3D Model B, 3D Model C, 3D Model D, 3D Model E and 3D Model F. Each 3D model includes a number of 2D views. For example, 3D Model A may include Views A1 through AN, 3D Model B may include Views B1 through BN, 3D Model C may include Views C1 through CN, 3D Model D may include Views D1 through DN, 3D Model E may include Views E1 through EN, and 3D Model F may include Views F1 through FN.

In response to the query 600, a 3D model that corresponds to the query is selected. The selected 3D model may be the model having the textual metadata from which the query was generated. In some implementations, the 3D model may be tagged with key words such that when the same or substantially similar key words are included in a query, the 3D model is identified and selected. In the “Golden Gate Bridge” example, a 3D model that is tagged as “Golden Gate Bridge” is selected. For illustrative purposes, 3D Model A, 3D Model B and 3D Model C are selected as being 3D models of the Golden Gate Bridge. 3D Models D-F correspond to other 3D models. For example, 3D Model D may be a 3D model of a skyscraper and 3D Model E may be a 3D model of a laptop computer.

The 2D views 610 that are included in each 3D model of the Golden Gate Bridge are then selected and analyzed to determine a ranking of representative 3D models. In some implementations, all of the 2D views are analyzed for each selected 3D model. In some implementations, a set of views is sampled, e.g., from a one dimensional direction, and then output. For example, for a given 3D model, one hundred views may be sampled along the z-axis (see FIG. 4a).

After the views 610 are selected, the view selector module 129 extracts image features from each selected view. As described above, the extracted image features are used to determine a feature vector for the corresponding view. The extracted image features are provided to the image feature scorer 132. The image feature scorer 132 is trained for the query using web images and corresponding user data 615, as previously described. In the “Golden Gate Bridge” query example, the image feature scorer 132 may access images that are tagged or otherwise identified as “Golden Gate Bridge” from an image database. The image feature scorer 132 also accesses any user data that is associated with the accessed images, such as the click and view history associated with each web image. The images and associated user data may be accessed by the image feature scorer 132 from a host server or from any other accessible storage location.

For each web image accessed, the image feature scorer 132 utilizes the user data to identify the image's popularity, as described above. To reiterate, the image feature scorer 132 may be trained for the query 600 by promoting features from images on which users have clicked and viewed heavily and by demoting features from unpopular or irrelevant images. For example, an image of the Golden Gate Bridge that was captured on a clear day where the entire structure is positioned symmetrically within the frame of the image would be likely accessed much more frequently by many different users than an image captured on an overcast day or from a camera positioned directly below the bridge, e.g., by a photographer on a boat travelling under the bridge. Using this technique, the image feature scorer 132 may determine the positive and negative web images of the Golden Gate Bridge.

The image feature scorer 132 may extract image features from the positive images and the negative images to generate a corresponding feature vector for each positive image and each negative image. The feature vectors of the positive/negative images may be compared to the feature vector of each selected view 610 to assign a relevance score (RS) to each selected view 610. The relevance score indicates the relevance of the query 600 to the selected view 610 and vice versa. Once the image feature scorer 132 is trained for the query 600, candidate views of the 3D model that are relevant to the query may be fed to the 3D model to obtain a relevance score for the candidate views. In some implementations, a high relevance score means that the view is more relevant to the corresponding query than a view with a low relevance score. The candidate views that have feature vectors that closely correspond to the feature vector of the most popular web image would be provided with higher relevance scores than the other candidate views of the 3D model.

In one illustrative example, one 3D model may represent the Golden Gate Bridge and another 3D model may represent an automobile. When these two 3D models are analyzed with regard to a “Golden Gate Bridge” query, the 2D rendering that provides the best view for the 3D model is the view that has the highest relevance score, as described previously with reference to FIGS. 3-6. In this case, the relevance score for the best view of the Golden Gate Bridge 3D model will be relatively high compared to the other 2D renderings of the Golden Gate Bridge 3D model. Similarly, for the automobile 3D model, the most representative 2D rendering for “Golden Gate Bridge” will still be the view that has the highest relevance score, e.g., for the view that shows a painting of the Golden Gate Bridge on the hood of the car, but the relevance score of the other views of the automobile 3D Model will be relatively low overall, e.g., because most other views of the car do not include an image of the Golden Gate Bridge.

The overall relevance score for a 3D model may be obtained by aggregating the individual relevance scores of at least some of the corresponding views. For example, View A1 may be assigned a relevance score of 80, View A2 may be assigned a relevance score of 60, and View AN may be assigned a relevance score of 55 such that an aggregate, e.g., average, relevance score for 3D Model A is 65. View B1 may be assigned a relevance score of 58, View B2 may be assigned a relevance score of 47, and View BN may be assigned a relevance score of 45 such that an aggregate, e.g., average, relevance score for 3D Model B is 50. View C1 may be assigned a relevance score of 95, View C2 may be assigned a relevance score of 68, and View CN may be assigned a relevance score of 71 such that an aggregate, e.g., average, relevance score for 3D Model C is 78.

A ranking table 620 is then generated for the query. The ranking table 620 lists the 3D models in order from highest aggregate relevance score to lowest aggregate relevance score relative to the query. Accordingly, 3D Model C is listed as being first in the table since it has the highest aggregate relevance score followed by 3D Model A and 3D Model B. Since 3D Model C is associated with the highest aggregate relevance score, 3D Model C is most likely representative of the 3D model associated with the query. 3D Model C is then associated with the query 600. Accordingly, 3D Model C would be retrieved and output in response to receiving a user search 625 from a user where terms of the search 625 are the same as or substantially similar to the query 600 for which the ranking table 620 is generated.

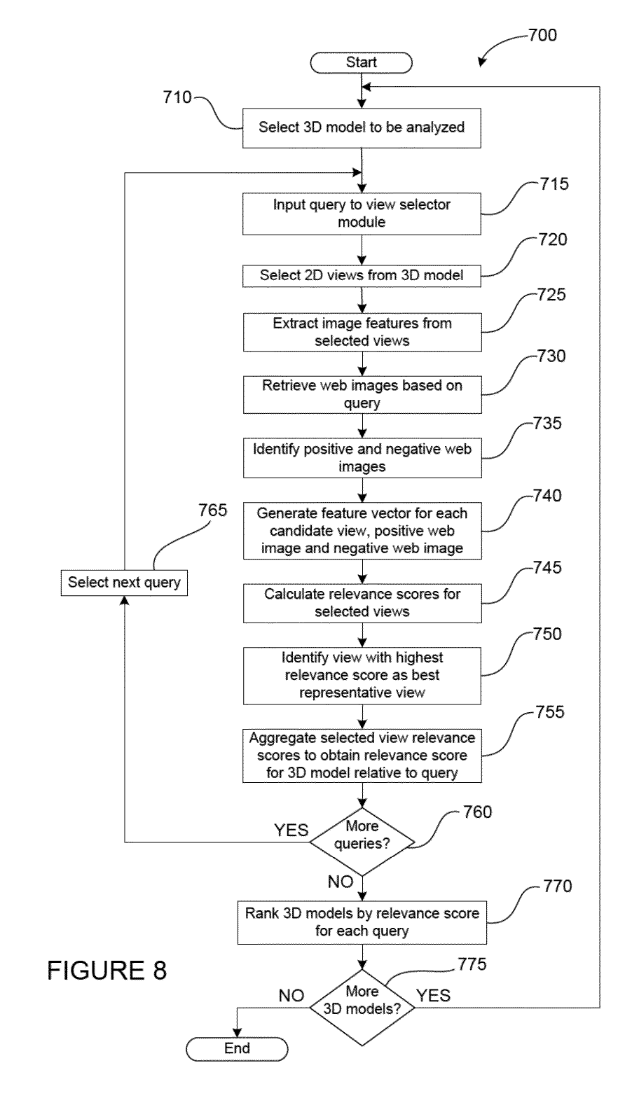

FIG. 8 illustrates a preprocessing stage of a method 700 for query-specific selection of a three dimensional model in accordance with some implementations. The method begins by selecting a 3D model to be analyzed for a query (block 710). The 3D model may be selected from local memory, a host server, or any other accessible storage area.

A query to be analyzed relative to the 3D model is input to a view selector module (block 715). The query may be obtained from queries submitted by users in search of a 3D model or may be generated for a particular 3D model based on textual metadata of the 3D model, as previously described. The view selector module processes the query to determine how relevant the 3D model is to the query, and vice versa.

At least some 2D views are selected from the associated 3D model (block 720). The selected views may be different two dimensional (2D) views of the 3D model such as images that are sampled from a view sphere of the 3D model (see FIG. 4b). In one example, the views are selected from the 3D model by rendering a set of thirty-six views which evenly sample a circle parallel to the x-y plane at a fixed z elevation.

Image features are extracted from the selected views (block 725). Example image features include view characteristics such as feature points, histograms of colors or any other type of data that provides information about the content or arrangement of the view. The image features are used to determine the most common features that are shared among images that are provided as results in response to the query.

Web images and associated user data are retrieved based on the query (block 730). For example, web images that are tagged “Golden Gate Bridge” or “automobile” may be retrieved from an image database. The user data that is retrieved may be used to identify whether or not the image is commonly accessed by users. For example, a click and view history of each image may be accessed to determine whether the image is popular or is often overlooked by users.

Some of the web images are identified as positive web images, e.g., the popular web images, and some of the web images are identified as negative web images, e.g., the overlooked web images (block 735). An image feature scorer is employed to rate the web images by promoting the image features of the positive web images and by demoting the image features of the negative web images. The set of positive web images and the set negative web images comprise a training set of images that are used to assign relevance scores to the views of the 3D model.

A feature vector is generated for each selected view of the 3D model, each positive web page and each negative web page (block 740). The feature vector is a functional representation of the image features for each selected view or web page, and is generated based on the query using well-known techniques. An image-feature vector conversion may be performed such that the image features of each selected view are represented as a feature vector.

A relevance score is calculated and assigned to each selected view of the 3D model (block 745). In some cases, a relevance score may also be calculated for each positive web image in the training set. The relevance score identifies the relevance of the image features of the selected view or the positive web image to the query. The relevance score for each selected view of the 3D model is determined by comparing the feature vector of the selected view with the feature vector of the positive web images such that the view having the feature vector that best corresponds to the most popular web image would have the highest relevance score.

As previously described, the view that has the highest relevance score is identified as the best representative view of the 3D model as identified in the query (block 750). The identification of the best representative view may be stored such that this view may be presented to a user in response to a 3D model search that corresponds to the query.

In order to determine the relevance score for the 3D model, the preprocessing stage continues beyond what has already been described with regard to identifying a best representative view for the 3D model. Namely, a relevance score for each 3D model relative to the query is determined by aggregating the relevance scores of the individual selected views of the 3D model (block 755). In order to score the 3D model as a whole, rather than just scoring the individual 2D views, the relevance scores of each of the selected 2D views are aggregated to provide an indicator of the relevance of the 3D model to the query. The relevance score may be aggregated by determining an average, mean or median relevance score for the selected views of the 3D model.

In some implementations, a weighted average of the selected view relevance scores is employed. For example, the ten 2D views that have the highest relevance scores are selected. The relevance scores for these ten views are then aggregated to determine the relevance score of the 3D model.

By aggregating the relevance scores of the selected views for the 3D model, a determination may be made as to what the 3D model likely represents. For example, for a 3D model of the Golden Gate Bridge, most (if not all) of the 2D renderings of the 3D model provide a view of an image that could be recognized as the Golden Gate Bridge. In another example, a 3D model may represent an automobile with an image of the Golden Gate Bridge painted on its hood. So, from one particular point of view, the automobile may provide an accurate representation of the Golden Gate Bridge. But an aggregate of the relevance scores for the views that comprise the 3D model of the automobile indicates that the 3D model does not represent the Golden Gate Bridge since the aggregate relevance score would be relatively low for the “Golden Gate Bridge” query.

A determination is then made as to whether additional queries are to be analyzed for the 3D model (block 760). In the event that additional queries are to be analyzed for the 3D model, processing moves to block 765 where another query for the 3D model is selected. Processing then returns to block 715 such that the next query can be processed for the 3D model as previously described.

In the event that no other queries are to be analyzed for the 3D model, processing proceeds to block 770 where the 3D models associated with a particular query are collected in a table and ranked by relevance score. In other words, the different queries are aggregated across all 3D models to create sorted lists of 3D models for each query. An index is created that includes the 3D models that contain a particular query, and those 3D models are ranked by relevance score associated with the query. The best representative view, as indicated by the selected view of the 3D model that has the highest relevance score with regard to the query, may also be identified such that this view is presented to a user when the corresponding 3D model is selected in response to the query. The process then terminates for the particular 3D model. If more 3D models are awaiting analysis (block 775), processing returns to block 710; otherwise, processing terminates.

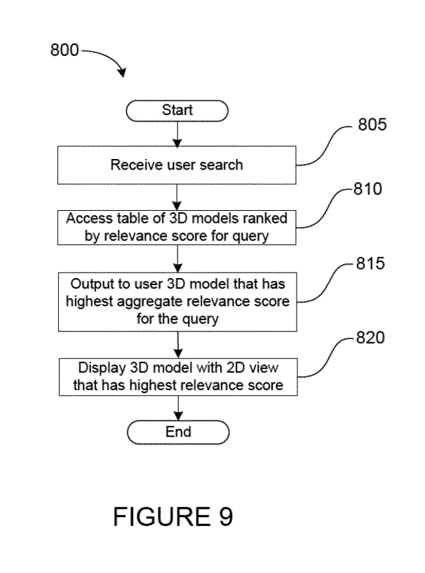

FIG. 9 illustrates a real time processing stage of a method 800 for query-specific selection of a three dimensional model (3D) in accordance with some implementations. The method begins when a search for a 3D model is received from a user (block 805). The search may be any character string that may correspond to a 3D model. An example search may be “Golden Gate Bridge” for users searching for a 3D model of the Golden Gate Bridge, or “automobile” for users searching for a 3D model of a car.

The table of 3D models ranked by aggregate relevance score is accessed for the corresponding search query (block 810). The aggregate relevance score for the 3D model is computed relative to the query, as described previously. For example, a table may be available for “Golden Gate Bridge” that includes a listing of 3D models that are relevant to the “Golden Gate Bridge” query.

The 3D model that has the highest aggregate relevance score for the query is selected from the 3D models that are relevant to the query and output to user (block 815). In some implementations, a set of 3D models that correspond to the highest relevance scores for the query are output to the user.

The 3D model (or set of 3D models) is displayed or is provided for presentation as the corresponding 2D view that was assigned the highest individual relevance score for the selected views for which relevance scores were calculated (block 820). In some implementations, the set of 3D models is displayed or provided for presentation in decreasing relevance score order such that the user may select an appropriate 3D model from the list of corresponding best representative 2D views. Processing then terminates.

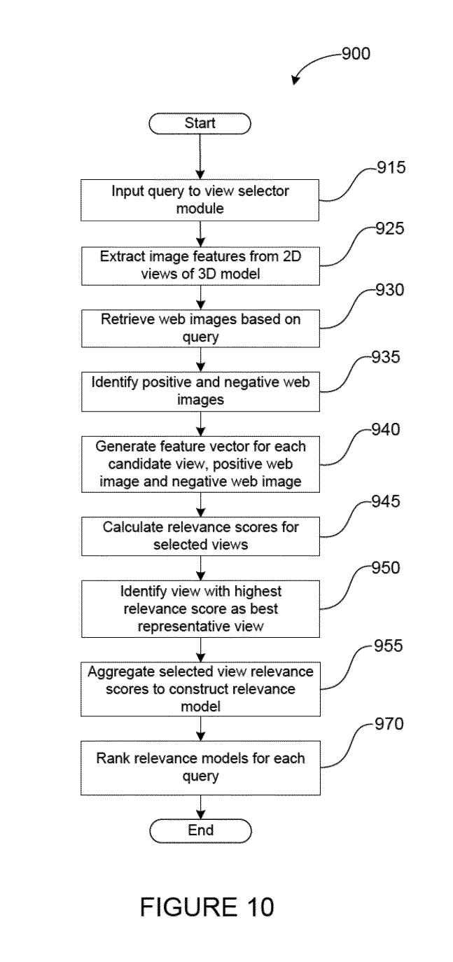

FIG. 10 illustrates a preprocessing stage of a method 900 for query-specific selection of a three dimensional model in accordance with some implementations. The method begins by inputting, to a view selector module, a query that is used to train a relevance model for the query (block 915). The query may be obtained from queries submitted by users in search of a 3D model or may be generated for a particular 3D model based on textual metadata of the 3D model, as previously described. The view selector module processes the query to generate a relevance model that identifies the relevance of the 3D model to the query, and vice versa.

Image features are extracted from selected 2D views of the 3D model for which the query is being trained (block 925). Example image features include view characteristics such as feature points, histograms of colors or any other type of data that provides information about the content or arrangement of the view. The image features are used to determine the most common features that are shared among images that are provided as results in response to the query.

Web images and associated user data are retrieved based on the query (block 930). For example, web images that are tagged “Golden Gate Bridge” or “automobile” may be retrieved from an image database. The user data that is retrieved may be used to identify whether or not the image is commonly accessed by users. For example, a click and view history of each image may be accessed to determine whether the image is popular or is often overlooked by users.

Some of the web images are identified as positive web images, e.g., the popular web images, and some of the web images are identified as negative web images, e.g., the overlooked web images (block 935). An image feature scorer is employed to rate the web images by promoting the image features of the positive web images and by demoting the image features of the negative web images. The set of positive web images and the set negative web images comprise a training set of images that are used to assign relevance scores to the views of the 3D model.

A feature vector is generated for each selected view of the 3D model, each positive web page and each negative web page (block 940). The feature vector is a functional representation of the image features for each selected view or web page, and is generated based on the query using well-known techniques. An image-feature vector conversion may be performed such that the image features of each selected view are represented as a feature vector.

A relevance score is calculated and assigned to each selected 2D view of the 3D model (block 945). In some cases, a relevance score may also be calculated for each positive web image in the training set. The relevance score identifies the relevance of the image features of the selected view or the positive web image to the query. The relevance score for each selected 2D view of the 3D model is determined by comparing the feature vector of the selected view with the feature vector of the positive web images such that the view having the feature vector that best corresponds to the most popular web image would have the highest relevance score.

As previously described, the view that has the highest relevance score is identified as the best representative view of the 3D model as identified in the query (block 950). The identification of the best representative view may be stored such that this view may be presented to a user in response to a 3D model search that corresponds to the query.

A relevance model is used in a real time processing stage to identify a 3D model that best corresponds to a query. In order to construct the relevance model, the preprocessing stage continues beyond what has already been described with regard to identifying a best representative view for the 3D model. Namely, a relevance model is constructed by aggregating the relevance scores of the individual selected views of the 3D model (block 955). In order to construct a relevance model for the 3D model as a whole, rather than just scoring the individual 2D views, the relevance scores of each of the selected 2D views are aggregated to construct the relevance model. The relevance scores may be aggregated by determining an average, mean or median relevance score for the selected views of the 3D model. The process then terminates for the query.

In some implementations, a weighted average of the selected view relevance scores is employed. For example, the ten 2D views that have the highest relevance scores are selected. The relevance scores for these ten views are then aggregated to determine the relevance model.

By aggregating the relevance scores of the selected 2D views, a determination may be made as to what the model likely represents. For example, for a 3D model of the Golden Gate Bridge, most (if not all) of the 2D renderings of the 3D model provide a view of an image that could be recognized as the Golden Gate Bridge. In another example, a 3D model may represent an automobile with an image of the Golden Gate Bridge painted on its hood. So, from one particular point of view, the automobile may provide an accurate representation of the Golden Gate Bridge. But an aggregate of the relevance scores for the views that comprise the 3D model of the automobile indicates that the 3D model does not represent the Golden Gate Bridge since the aggregate relevance score would be relatively low for the “Golden Gate Bridge” query.

After the relevance scores of the selected views for the 3D model are aggregated to construct the relevance model, the query may be analyzed for other 3D models to construct other relevance models for the query. The relevance models associated with the query are then ranked (block 970). In other words, different queries are aggregated across all models to create sorted lists of relevance models for each query. An index is created that includes the relevance models associated with a particular query, and those models are ranked by relevance score. The best representative view, as indicated by the selected view of the 3D model that has the highest relevance score with regard to the query, may also be identified such that this view is presented to a user when the corresponding 3D model is selected in response to the query. The process may be repeated to train a relevance model for other queries.

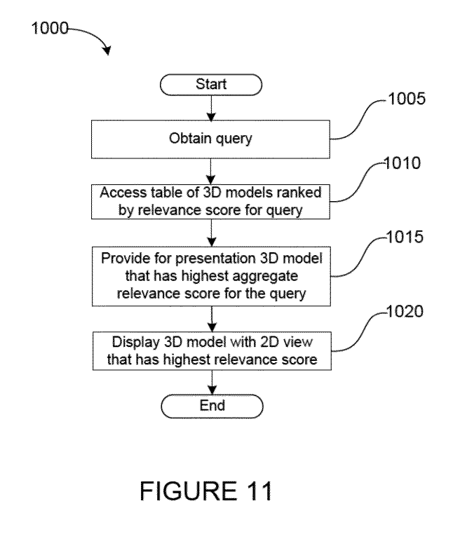

FIG. 11 illustrates a real time processing stage of a method 1000 for query-specific selection of a three dimensional model (3D) in accordance with some implementations. The method begins when a query for a 3D model is obtained (block 1105). The query may be a search received from a user. The search may be any character string that may correspond to a 3D model. An example search may be “Golden Gate Bridge” for users searching for a 3D model of the Golden Gate Bridge, or “automobile” for users searching for a 3D model of a car.

The table of 3D models ranked by aggregate relevance score is accessed for the corresponding query (block 1110). The aggregate relevance score for the 3D model is computed relative to the query, as described previously. For example, a table may be available for “Golden Gate Bridge” that includes a listing of 3D models that are relevant to the “Golden Gate Bridge” query.

The 3D model that has the highest aggregate relevance score for the query is selected from the 3D models that are relevant to the query and is provided for presentation (block 1115). For example, 3D model that has the highest aggregate relevance score may be prepared for output to a display. In some implementations, a set of 3D models that correspond to the highest relevance scores for the query are prepared for output to the user.

The 3D model (or set of 3D models) is displayed or is provided for presentation as the corresponding 2D view that was assigned the highest individual relevance score for the selected views for which relevance scores were calculated (block 1120). In some implementations, the set of 3D models is displayed or provided for presentation in decreasing relevance score order such that the user may select an appropriate 3D model from the list of corresponding best representative 2D views. Processing then terminates.

As described above, a query for a specific 3D model may be analyzed relative to different 3D models. For each 3D model for which the query is analyzed, a relevance score is computed for at least some 2D views of the 3D model. High relevance scores indicate that the corresponding 2D views correspond to views that best represent the 3D model. The relevance scores of the individual 2D views are aggregated to provide the 3D model with its own relevance score. The 3D model that has the highest aggregate relevance score is identified as the 3D model that is most relevant to the query. The relevance score of different 3D models also allows for a comparison of the different 3D models.

Although the disclosure herein has been described with reference to particular implementations, it is to be understood that these implementations are merely illustrative of the principles and applications of the disclosure. It is therefore to be understood that numerous modifications may be made to the illustrative implementations and that other arrangements may be devised without departing from the spirit and scope as defined by the appended claims.

1-22. (canceled)

23. A computer-implemented method comprising:
receiving a search query;
selecting multiple, different two-dimensional views of a three-dimensional model that is identified as responsive to the search query;
generating an image query that includes a query term that matches a query term of the search query;
obtaining images that are identified as response to the image query that includes the query term that matches the query term of the search query;
generating a respective score for each one of the multiple, different two-dimensional views based on one or more similarities between the views and the images that are identified as response to the image query that includes the query term that matches the query term of the search query;
selecting a particular two-dimensional view of the three-dimensional model from among the multiple, different two-dimensional views as a representative view of the three-dimensional model based on the scores of the multiple, different two-dimensional views; and
providing the representative view of the three-dimensional model in response to the search query.

24. The method of claim 23, comprising:
identifying the three-dimensional model that is responsive to the search query based on a keyword match between a query term of the search query and a tag of the model.

25. The method of claim 23, comprising:
generating the multiple, different two-dimensional views by sampling the three-dimensional model at different view points.

26. (canceled)

27. The method of claim 23, wherein generating a respective score for each one of the multiple, different two-dimensional views based on one or more similarities between the views and the images that are identified as response to the image query that includes the query term that matches the query term of the search query comprises:
extracting view features from the multiple, different two-dimensional views;
extracting image features from the images that are identified as responsive; and
for each of the multiple different two-dimensional views, generating the respective score based on comparing the extracted view features of the view with the extracted image features.

28. The method of claim 23, wherein selecting the particular two-dimensional view of the three-dimensional model from among the multiple, different two-dimensional views as a representative view of the three-dimensional model based on the scoring of the multiple, different two-dimensional views comprises:
determining the particular two-dimensional view of the three-dimensional model has the highest score, indicating that the particular two-dimensional view is most similar to the images that are identified as responsive to the image query; and
in response to the determination, selecting the particular two-dimensional view of the three-dimensional model.

29. The method of claim 23, wherein providing the representative view of the three-dimensional model in response to the search query comprises:
identifying the three-dimensional model is response to the search query based on the scoring of the multiple, different two-dimensional views of the three-dimensional model; and
in response to identifying the three-dimensional model is response to the search query, providing the representative view of the three-dimensional model in response to the search query.

30. A system comprising:
one or more computers and one or more storage devices storing instructions that are operable, when executed by the one or more computers, to cause the one or more computers to perform operations comprising:
receiving a search query;
selecting multiple, different two-dimensional views of a three-dimensional model that is identified as responsive to the search query;
generating an image query that includes a query term that matches a query term of the search query;
obtaining images that are identified as response to the image query that includes the query term that matches the query term of the search query;
generating a respective score for each one of the multiple, different two-dimensional views based on one or more similarities between the views and the images that are identified as response to the image query that includes the query term that matches the query term of the search query;
selecting a particular two-dimensional view of the three-dimensional model from among the multiple, different two-dimensional views as a representative view of the three-dimensional model based on the scores of the multiple, different two-dimensional views; and
providing the representative view of the three-dimensional model in response to the search query.

31. The system of claim 30, wherein the operations comprise:
identifying the three-dimensional model that is responsive to the search query based on a keyword match between a query term of the search query and a tag of the model.

32. The system of claim 30, wherein the operations comprise:
generating the multiple, different two-dimensional views by sampling the three-dimensional model at different view points.

33. (canceled)

34. The system of claim 30, wherein generating a respective score for each one of the multiple, different two-dimensional views based on one or more similarities between the views and the images that are identified as response to the image query that includes the query term that matches the query term of the search query comprises:
extracting view features from the multiple, different two-dimensional views;
extracting image features from the images that are identified as responsive; and
for each of the multiple different two-dimensional views, generating the respective score based on comparing the extracted view features of the view with the extracted image features.

35. The system of claim 30, wherein selecting the particular two-dimensional view of the three-dimensional model as a representative view of the three-dimensional model based on the scoring of the multiple, different two-dimensional views comprises:
determining the particular two-dimensional view of the three-dimensional model has the highest score, indicating that the particular two-dimensional view is most similar to the images that are identified as responsive to the image query; and
in response to the determination, selecting the particular two-dimensional view of the three-dimensional model.

36. The system of claim 30, wherein providing the representative view of the three-dimensional model in response to the search query comprises:
identifying the three-dimensional model is response to the search query based on the scoring of the multiple, different two-dimensional views of the three-dimensional model; and
in response to identifying the three-dimensional model is response to the search query, providing the representative view of the three-dimensional model in response to the search query.

37. A non-transitory computer-readable medium storing software comprising instructions executable by one or more computers which, upon such execution, cause the one or more computers to perform operations comprising:
receiving a search query;
selecting multiple, different two-dimensional views of a three-dimensional model that is identified as responsive to the search query;
generating an image query that includes a query term that matches a query term of the search query;
obtaining images that are identified as response to the image query that includes the query term that matches the query term of the search query;
generating a respective score for each one of the multiple, different two-dimensional views based on one or more similarities between the views and the images that are identified as response to the image query that includes the query term that matches the query term of the search query;
selecting a particular two-dimensional view of the three-dimensional model from among the multiple, different two-dimensional views as a representative view of the three-dimensional model based on the scores of the multiple, different two-dimensional views; and
providing the representative view of the three-dimensional model in response to the search query.

38. The medium of claim 37, wherein the operations comprise:
identifying the three-dimensional model that is responsive to the search query based on a keyword match between a query term of the search query and a tag of the model.

39. The medium of claim 37, wherein the operations comprise:
generating the multiple, different two-dimensional views by sampling the three-dimensional model at different view points.

40. (canceled)

41. The medium of claim 37, wherein generating a respective score for each one of the multiple, different two-dimensional views based on one or more similarities between the views and the images that are identified as response to the image query that includes the query term that matches the query term of the search query comprises:
extracting view features from the multiple, different two-dimensional views;
extracting image features from the images that are identified as responsive; and
for each of the multiple different two-dimensional views, generating the respective score based on comparing the extracted view features of the view with the extracted image features.

42. The medium of claim 37, wherein selecting the particular two-dimensional view of the three-dimensional model as a representative view of the three-dimensional model based on the scoring of the multiple, different two-dimensional views comprises:
determining the particular two-dimensional view of the three-dimensional model has the highest score, indicating that the particular two-dimensional view is most similar to the images that are identified as responsive to the image query; and
in response to the determination, selecting the particular two-dimensional view of the three-dimensional model.

43. The medium of claim 37, wherein providing the representative view of the three-dimensional model in response to the search query comprises:
identifying the three-dimensional model is response to the search query based on the scoring of the multiple, different two-dimensional views of the three-dimensional model; and
in response to identifying the three-dimensional model is response to the search query, providing the representative view of the three-dimensional model in response to the search query.
